(19) United States
(12) Patent Application Publication
(10) Pub. No.: US 2021/0348405 A1
(43) Pub. Date: Nov. 11, 2021

(54) RAPID DEPLOY SELF POWERED ALTERNATIVE EMERGENCY RESPONSE FACILITIES, SYSTEMS, AND METHODS

(71) Applicant: mustER RDU Inc., Columbus, OH (US)

(72) Inventor: Darin Hadinger, Columbus, OH (US)

(21) Appl. No.: 17/315,305

(22) Filed: May 8, 2021

Related U.S. Application Data
(60) Provisional application No. 63/021,902, filed on May 8, 2020.

(51) Int. Cl. E04H 1/12; E04H 15/20; E04B 1/343; E04B 1/348; H02J 3/38

(52) U.S. Cl. CPC E04H 1/1205; E04H 15/20; H02J 2300/20; E04B 1/34869; H02J 3/381; E04B 1/34336

(57) ABSTRACT

The subject disclosure relates to rapid deployable, self-powered, alternative emergency response facilities, systems and methods.

### CROSS-REFERENCE TO RELATED APPLICATIONS

This patent application claims priority to and claims the benefit of priority to U.S. Provisional Patent Application No. 63/021,902 filed on May 8, 2020, and entitled “Rapid Deploy Self Powered Alternative Emergency Response Facilities, Systems, and Methods”. The entirety of the disclosure of the aforementioned application is considered part of, and is incorporated by reference in, the disclosure of this application.

### BACKGROUND

Given the high-risk of viral spread due to community transmission of such viruses such as the global COVID-19 outbreak, there is a need to provide care to large numbers of people quickly and efficiently. For instance, the COVID-19 pandemic resulted in the spread of COVID-19 to large populations of people and quickly impacted residents, families, employees and others with serious illness, complications, and death. As a result of a surge in contraction of the virus, health care facilities experienced capacity issues and in some instances were unable to service the patient demand given its medical capacity. Given such challenges related to medical capacity, there is a need for new technologies and solutions to address the need for greater medical capacity during pandemics or other situations that create such need.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments, described herein are systems, devices, apparatuses, methods, and computer-implemented methods configured to provide immediate infrastructure to address critical needs for emergency medical centers, rural hospitals, treatment centers for at-risk populations, and/or housing for respective populations (e.g., homeless populations).

According to an embodiment, a system is provided. The system comprises containerized units configured to expand into shelter elements integrated with containers. The deployment of the system of expanded shelters and containers can be configured as emergency medical centers utilized for rapid response to emergency situations. Furthermore, such systems are configured for scale such that the system can deploy adequate facilities with integrated utilities as required to satisfy the emergency situation.

### BRIEF DESCRIPTION OF THE DRAWINGS

FIG. 1 illustrates a diagram of an example, non-limiting response system comprising reusable units in response to an emergency, pandemic or other situational need in accordance with one or more embodiments described herein.

FIG. 2A illustrates a diagram of an example, non-limiting response system comprising reusable units such as an integrated array of shelter deployments in response to an emergency, pandemic or other situational need in accordance with one or more embodiments described herein.

FIG. 2B illustrates a diagram of an example, non-limiting response system comprising reusable units such as an integrated array of shelter deployments in response to an emergency, pandemic or other situational need in accordance with one or more embodiments described herein.

FIG. 3A illustrates a perspective view of an example, non-limiting airbeam shelter deployment of a response system comprising reusable units in response to an emergency, pandemic or other situational need in accordance with one or more embodiments described herein.

FIG. 3B illustrates a top view of an example, non-limiting airbeam shelter deployment of a response system comprising reusable units in response to an emergency, pandemic or other situational need in accordance with one or more embodiments described herein.

FIG. 3C illustrates a side view of an example, non-limiting airbeam shelter deployment of a response system comprising reusable units in response to an emergency, pandemic or other situational need in accordance with one or more embodiments described herein.

FIG. 3D illustrates a rear view of an example, non-limiting airbeam shelter deployment of a response system comprising reusable units in response to an emergency, pandemic or other situational need in accordance with one or more embodiments described herein.

FIG. 4A illustrates a diagram of an example, non-limiting connection structure of a response system comprising reusable units such as an integrated array of shelter deployments in response to an emergency, pandemic or other situational need in accordance with one or more embodiments described herein.

FIG. 4B illustrates a diagram of an example, non-limiting intensive care unit of a response system comprising reusable units such as an integrated array of shelter deployments in response to an emergency, pandemic or other situational need in accordance with one or more embodiments described herein.

FIG. 5A illustrates a perspective view of an example, non-limiting intensive care unit of a response system comprising reusable units such as an integrated array of shelter deployments in response to an emergency, pandemic or other situational need in accordance with one or more embodiments described herein.

FIG. 5B illustrates a perspective view of an example, non-limiting housing unit of a response system comprising reusable units such as an integrated array of shelter deployments in response to an emergency, pandemic or other situational need in accordance with one or more embodiments described herein.

FIG. 6A illustrates a perspective view of an example, non-limiting housing unit interior of a response system comprising reusable units such as an integrated array of shelter deployments in response to an emergency, pandemic or other situational need in accordance with one or more embodiments described herein.

FIG. 6B illustrates a perspective view of an example, non-limiting sleeping pod within a housing unit of a response system comprising reusable units such as an integrated array of shelter deployments in response to an emergency, pandemic or other situational need in accordance with one or more embodiments described herein.

FIG. 6C illustrates a perspective view of an example, non-limiting sleeping pod within a housing unit of a response system comprising reusable units such as an integrated array of shelter deployments in response to an emergency, pandemic or other situational need in accordance with one or more embodiments described herein.

FIG. 7A illustrates a perspective view of an example, non-limiting washroom within a housing unit of a response system comprising reusable units such as an integrated array of shelter deployments in response to an emergency, pandemic or other situational need in accordance with one or more embodiments described herein.

FIG. 7B illustrates a perspective view of an example, non-limiting washroom within a housing unit of a response system comprising reusable units such as an integrated array of shelter deployments in response to an emergency, pandemic or other situational need in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, disclosed herein are systems, devices and methods for responding to urgent situations requiring shelter, medical assistance, or other needs for additional standalone reusable units. In a non-limiting embodiment, the systems disclosed herein include reusable and scalable shelter units configured to implement a mass response to pandemics such as the COVID-19 pandemic of 2020. The systems are configured to deploy reusable units that can isolate individuals infected with COVID-19 to an enclosed area (e.g., an inflatable shelter) such that the infected individual can receive safe treatment in an environment equipped to perform such treatments and in a manner that minimizes the risk of further spread of a virus or other biological agent to a healthy population.

For instance, a prison population contains individuals within a confined area (e.g., jail cells) that can allow for the fast spreading of a biological agent such as the COVID-19 virus. However, by implementing the integrated shelter systems disclosed herein, the population of infected individuals can be removed from the prison environment and undergo treatment in an isolated shelter the mitigates the further spread of the virus and facilitates effective medical treatment of the individual within a safe environment. In an aspect, the systems disclosed herein are configured with custom ventilation and sanitation systems that contain airborne viruses to the shelter environment. Furthermore, the deployable shelter systems disclosed herein are configured to allow for the deployment of an operational shelter configured to accommodate infected patients within four hours from the start of deployment tasks.

Furthermore, the disclosed systems are configured to be powered by independent power sources such as customized solar power sources, wind power generators, and other power generators all of which are stand alone and off-grid power sources. Accordingly, the disclosed systems are not dependent on public infrastructure (e.g., grid integrations) availability to erect the shelters. As such, the systems disclosed herein can be deployed in a variety of locations. Also, the deployable shelter systems include integrated shelter units that can be structurally configured to execute particular roles. For instance, in an embodiment an inflatable air beam shelter can be configured as an Intensive Care Unit (ICU) that can be separated via hermetically sealed doors from other shelter units such as housing shelters, staff shelter units, bath and laundry shelter units. As such, the ICU shelter can contain the spread of airborne pathogens to the confines of that shelter unit. In another aspect, the disclosed systems can include utilities, septic systems, HVAC systems, bath and shower systems, and shelters configured to accommodate staff commissioned to work within the shelters of the system.

In another aspect, the rapidly deployable shelter systems can be deployed in a range of conditions due to the weather-independent inflation-based deployment mechanisms of many of the shelter units. Furthermore, the entire system can be shipped to a site location in shipping containers such as three to five shipping containers. The system can require a location area of 100 feet by 50 feet in some embodiments. In an instance, the inflatable shelters can be self-contained within a staff hard container and the inflatable shelters can inflate out of each side of the hard shelter in less than 20 minutes. In another aspect, the systems disclosed herein can include independent stand-alone power sources such as a microgrid power unit. For instance, a microgrid power unit can provide 60 kw of electricity and can be configured to integrate with the shelter systems disclosed herein. Furthermore, such mircrogrid can include pre-charged batteries. Furthermore, the shelter elements of the systems disclosed herein can utilize solar canopy technologies bonded to the outer surface of the airbeam shelters. In another aspect, stand-alone wind turbines can be integrated to the microgrid to provide an additional source of power to the shelter systems. In another embodiment, power generators (e.g., 60 kw generator in some embodiments.) can be employed to provide power for septic systems, HVAC systems and provide a backup power source.

In other embodiments, the disclosed systems can integrate incinerating sanitary septic systems configured to incinerate water waste into sanitary ash on site. Furthermore, all sub-systems can be monitored, tracked, generate data, and analyzed using software systems integrated to all system components. In another aspect, the system can include communication sub-systems (e.g., Wi-Fi and integrated communication mechanisms), additive manufacturing capabilities (e.g., 3D printers to produce medical supplies), and essential equipment (e.g., shower, laundry trucks), power clusters, mobile HVAC units, electrical alternating current connections, and food storage containers.

The disclosed systems are illustrated and described further in the below figures.

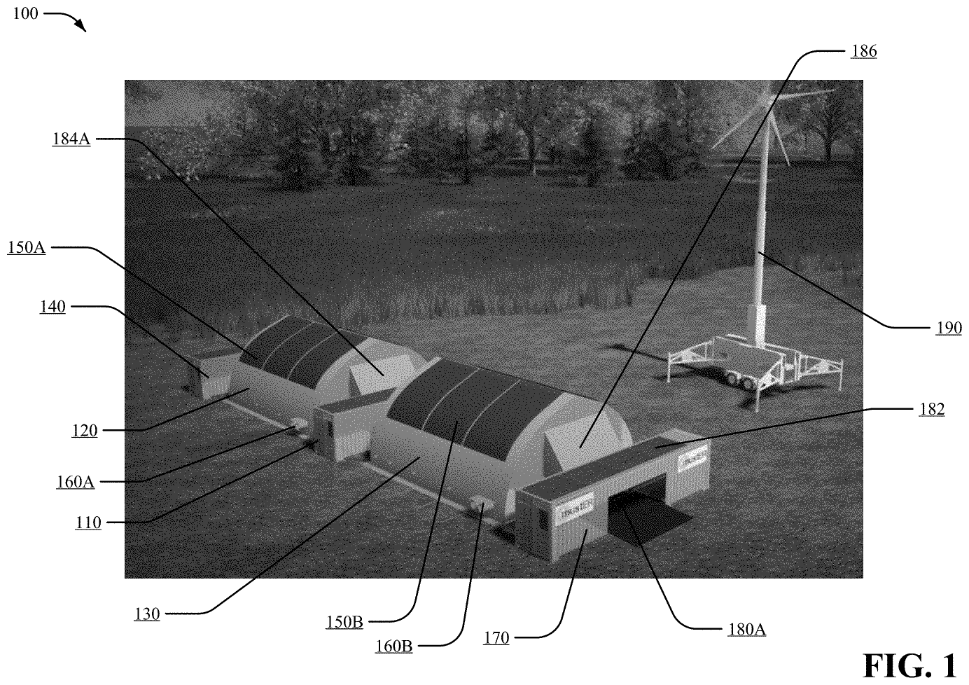

FIG. 1 illustrates a diagram of an example, non-limiting response system 100 comprising reusable units in response to an emergency, pandemic or other situational need in accordance with one or more embodiments described herein.

In an aspect, system 100 can comprises first hard container element 110, first airbeam shelter 120, second airbeam shelter 130, second hard container element 140, first flexible solar canopy 150A, second flexible solar canopy 150B, first inputs 160A, second inputs 160B, third hard container element, first entrance of third hard container element 180A, third flexible solar canopy 182, first integration connection 184A, second integration connection 186, and portable renewable energy generator.

In a non-limiting embodiment, first hard container element 110 comprises a hard containment shell configured to accommodate individuals within the interior and configured to integrate with other shelter system elements. In an aspect, first hard container element 110 includes deflated air beam shelters within the interior of the hard container. The air beam shelters can be self-contained within the hard container element 110 (e.g., a staff container) and are capable of inflating out of openings in the hard shelter located on each side of the staff container within twenty minutes from the start of inflation and upon deployment of ramps from the staff container.

In another aspect, disclosed is first airbeam shelter 120. In an embodiment, first airbeam shelter 120 can be configured as an ICU that is segregated from other housings of the system 100. Furthermore, first airbeam shelter 120 can be configured to allow for testing activities, triage activities, and patient intake operations. First airbeam shelter 120 can comprise necessary medical equipment, treat 24-40 patients in an embodiment. In other embodiments, airbeam shelter 120 can accommodate over one hundred patients. Furthermore, first airbeam shelter 120 can be configured as a negative pressurized unit that can be hermetically sealed and include HVAC with appropriate air filtration systems, HEPA filters, and air change technology. Also, first airbeam shelter 120 can be configured to rapidly self-deploy, include a high pressure airbeam and/or airframe shelter system. Furthermore, the system can incorporate two endwalls with a large maintenance door on each wall and two temper side doors on the center portion of the airbeam shelter. In another aspect, the airbeam shelter can include floors that are integrated, removable and replaceable within the airframe.

The first airbeam shelter 120 can also include side ECU ports, an integrated plenum, doorways with temper adaptors, lighting compatibility systems, mechanisms to allow for trailer system transportation, environmental control systems, electrical power capabilities, interior clear spans of thirty feet, personnel supports of between 28-40 people, and integration capabilities to integrate with other hard shelters and/or inflatable airbeam shelters. In another embodiment, system 100 can include a second airbeam shelter 130 configured to have at least the same capabilities as first airbeam shelter 120. In another aspect, first airbeam shelter 120 and second airbeam shelter 130 can include flexible solar canopies to supply, at least partially, power to the system 100 elements (e.g., shelters, medical equipment, utilities, etc.). In an aspect, first flexible solar canopy 150A can be configured as a lightweight solar module subsystem that bond to the outer surface of the airbeam shelter without need of a ballast or racking mechanism. Furthermore, first flexible solar canopy 150A can sustain high wind loads and can be configured to endure hazardous conditions associated with seismic hazard areas. In an aspect, second flexible solar canopy can be configured in the same manner and with the same capabilities as first flexible solar canopy 150A.

In another aspect, system 100 can be self-powering via the integration of portable renewable energy generator 190. For instance, portable renewable energy generator 190 can be configured as a low wind speed optimized energy generator that is a stand alone generator unit. Furthermore, portable renewable energy generator 190 can operate independent of a power grid and can be operated via an instrument panel that allows for the control of power output to respective system 100 elements.

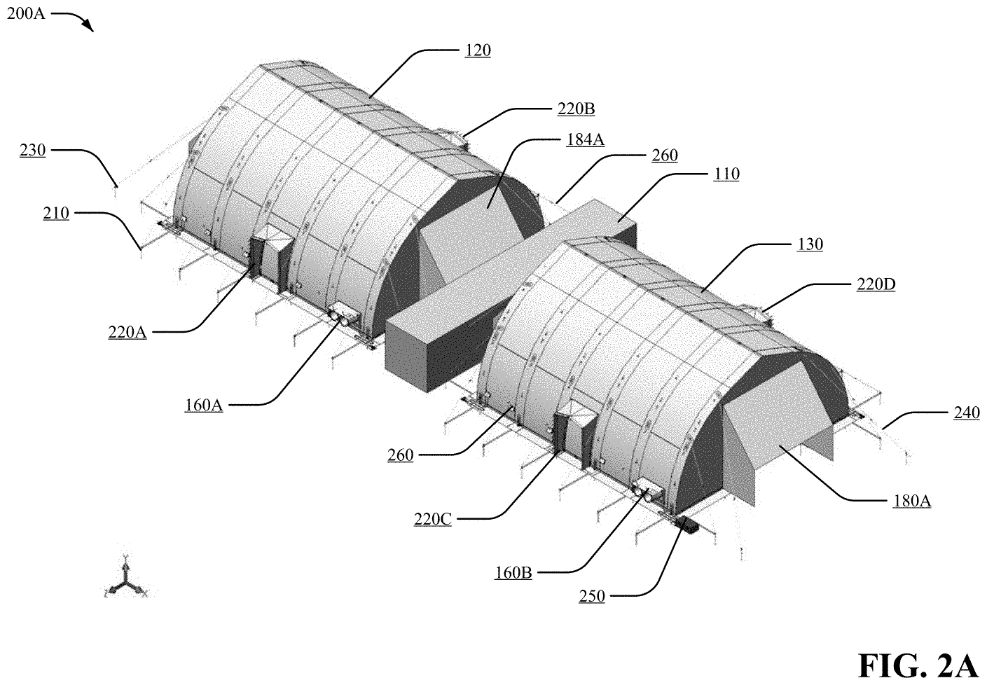

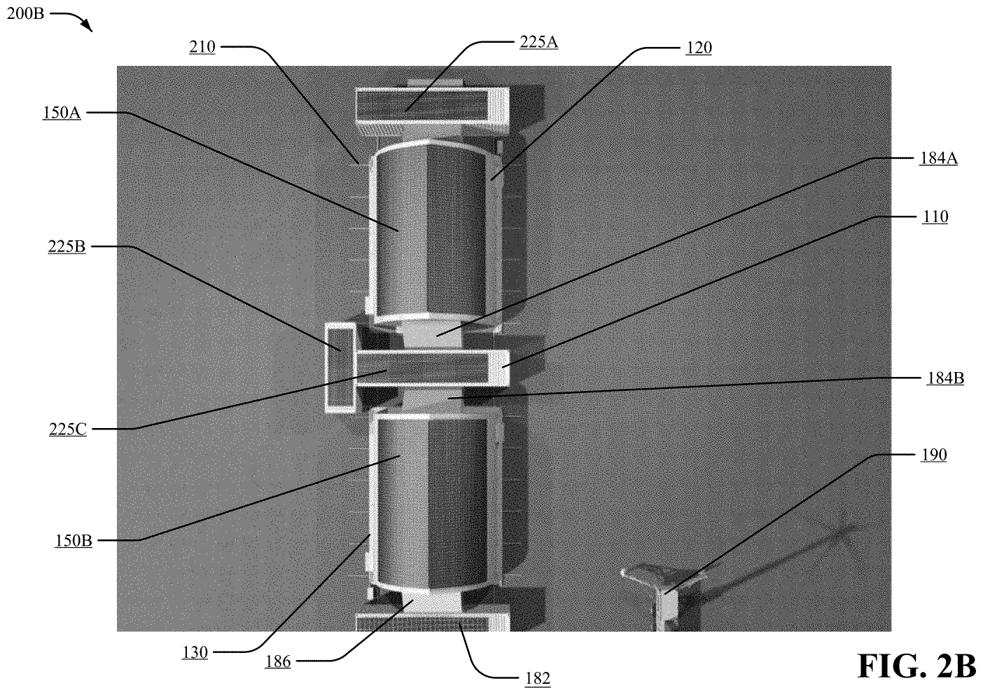

Turning now to FIG. 2A, illustrated is a diagram of an example, non-limiting response system 200A comprising reusable units such as an integrated array of shelter deployments in response to an emergency, pandemic or other situational need in accordance with one or more embodiments described herein. Repetitive description of like elements employed in other embodiments described herein is omitted for sake of brevity.

In an aspect, system 200A can comprises first hard container element 110, first airbeam shelter 120, second airbeam shelter 130, first inputs 160A, second inputs 160B, first entrance of third hard container element 180A, first integration connection 184A, first ground anchor 210, first maintenance door 220A, second maintenance door 220B, third maintenance door 220C, fourth maintenance door 220D, second ground anchor 230, third ground anchor 240, external box 250, and fourth ground anchor 260. In an aspect, first ground anchor 210 and other disclosed ground anchors can provide a ground anchoring support system by employing a series of stakes or a series of pins such as a twelve inch stake. In a non-limiting embodiment, a first airbeam shelter 120 or second airbeam shelter 130 can include eighteen stakes to facilitate anchoring the shelter to the ground.

Turning now to FIG. 2B, illustrated is a diagram of an example, non-limiting response system 200B comprising reusable units such as an integrated array of shelter deployments in response to an emergency, pandemic or other situational need in accordance with one or more embodiments described herein. Repetitive description of like elements employed in other embodiments described herein is omitted for sake of brevity.

In an aspect, system 200B can comprises first hard container element 110, first airbeam shelter 120, second air beam shelter 130, first flexible solar canopy 150A, second flexible solar canopy 150B, first integration connection 184A, third integration connection 184B, second integration connection 186, portable renewable energy generator 190, first ground anchor 210, fourth flexible solar canopy 225A, fifth flexible solar canopy 225B, sixth flexible solar canopy 225C, and third flexible solar canopy 182.

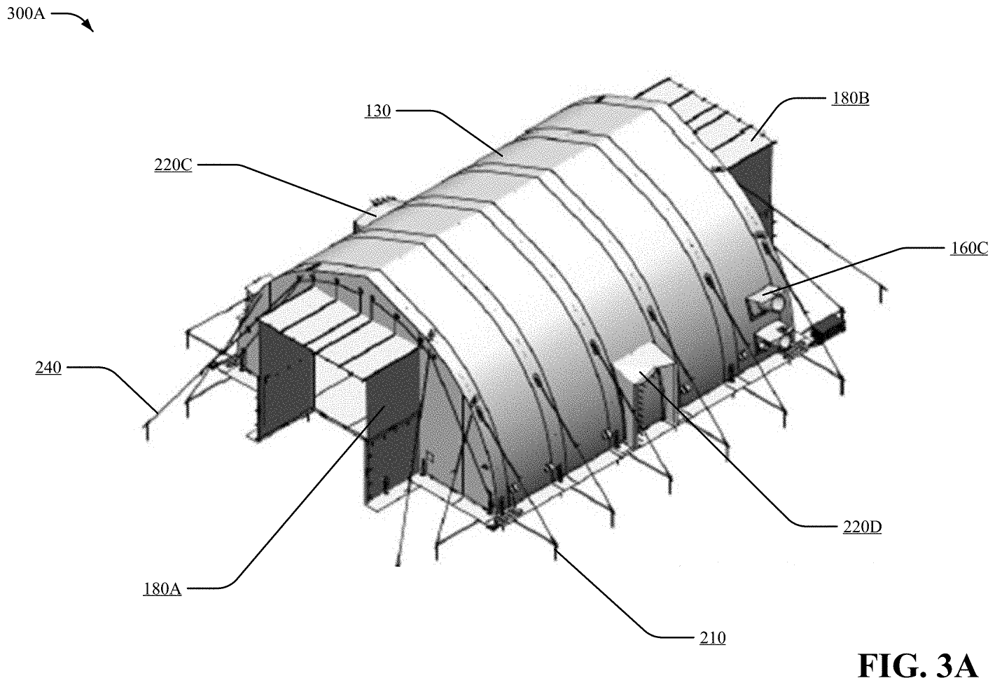

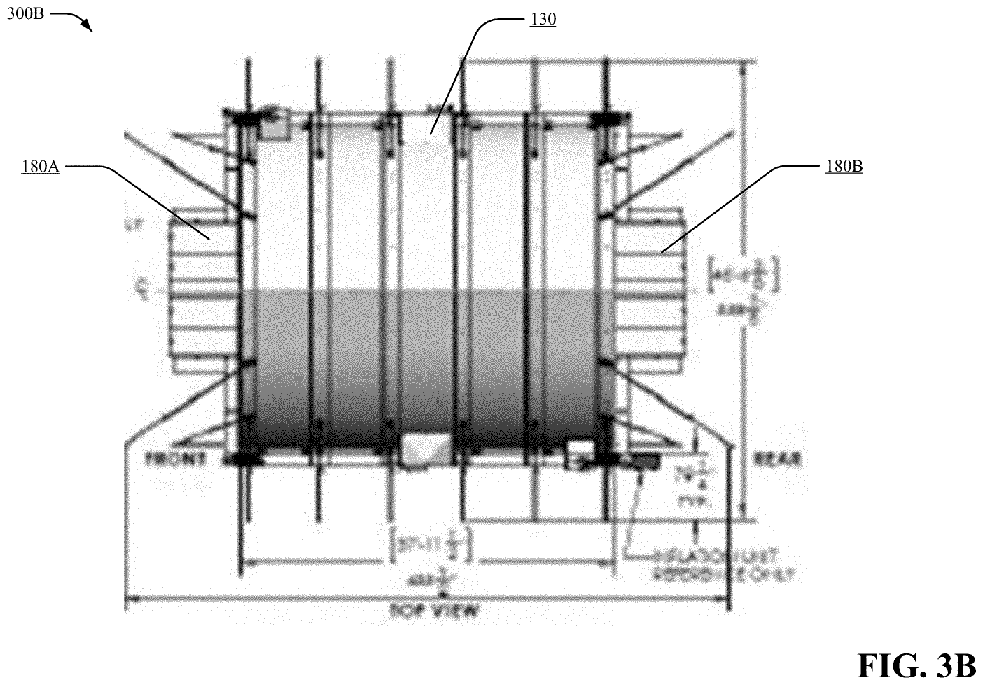

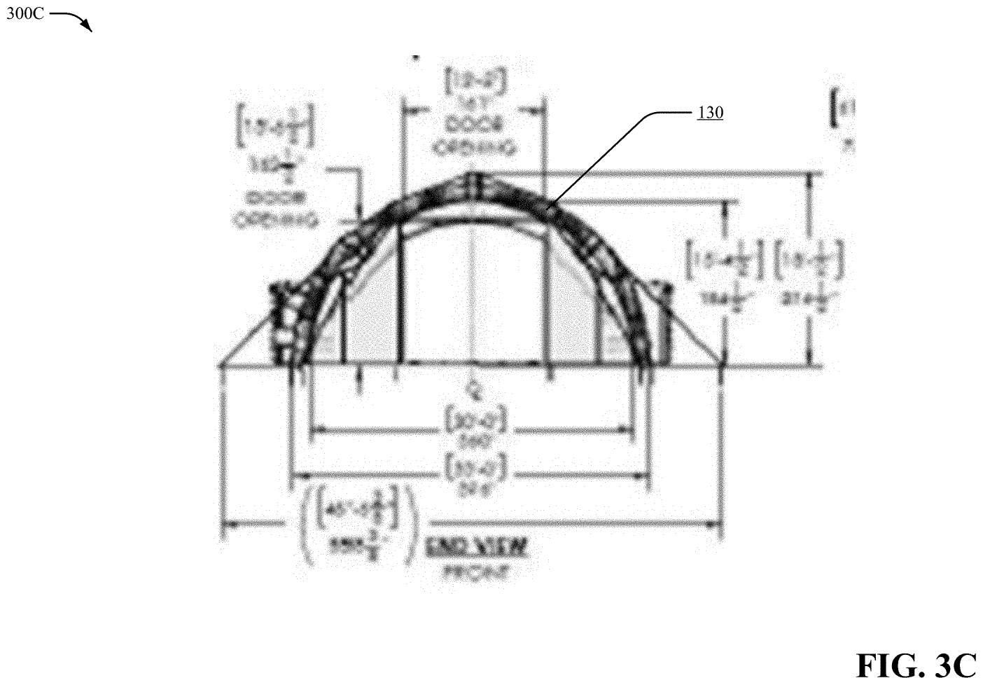

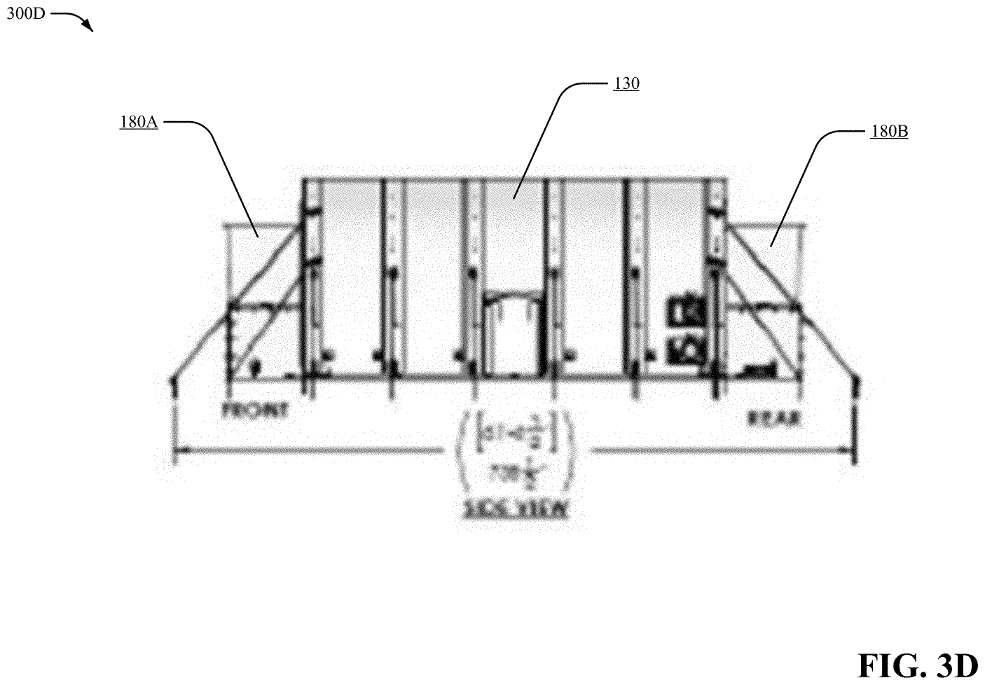

Turning now to FIG. 3A, illustrated is a perspective view of an example, non-limiting air beam shelter deployment of a response system 300A comprising reusable units in response to an emergency, pandemic or other situational need in accordance with one or more embodiments described herein. Repetitive description of like elements employed in other embodiments described herein is omitted for sake of brevity. In an aspect, system 300A can comprise second air beam shelter 130 and its outer cover, third inputs 160C, first temper side door 180A, second temper side door 180B, first ground anchor 210, third maintenance door 220C, fourth maintenance door 220D, and third ground anchor 240.

Turning now to FIG. 3B, illustrated is a top view of an example, non-limiting air beam shelter deployment of a response system 300B comprising reusable units in response to an emergency, pandemic or other situational need in accordance with one or more embodiments described herein. Repetitive description of like elements employed in other embodiments described herein is omitted for sake of brevity. In an aspect, system 300B can comprise an airframe outer cover 130, first temper side door 180A, and second temper side door 180B.

Turning now to FIG. 3C, illustrated is a side view of an example, non-limiting airbeam shelter deployment of a response system 300C comprising reusable units in response to an emergency, pandemic or other situational need in accordance with one or more embodiments described herein. Repetitive description of like elements employed in other embodiments described herein is omitted for sake of brevity. In an aspect, system 300C can comprise an airframe outer cover 130.

Turning now to FIG. 3D, illustrated is a rear view of an example, non-limiting airbeam shelter deployment of a response system 300D comprising reusable units in response to an emergency, pandemic or other situational need in accordance with one or more embodiments described herein. Repetitive description of like elements employed in other embodiments described herein is omitted for sake of brevity. In an aspect, system 300D can comprise an airframe outer cover 130, first temper side door 180A, and second temper side door 180B.

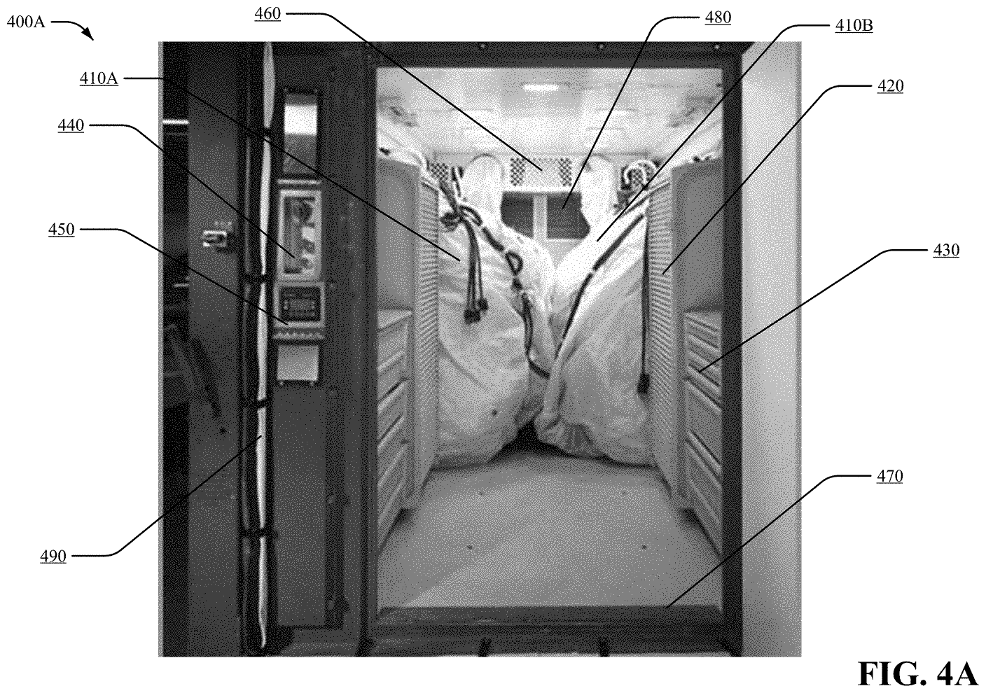

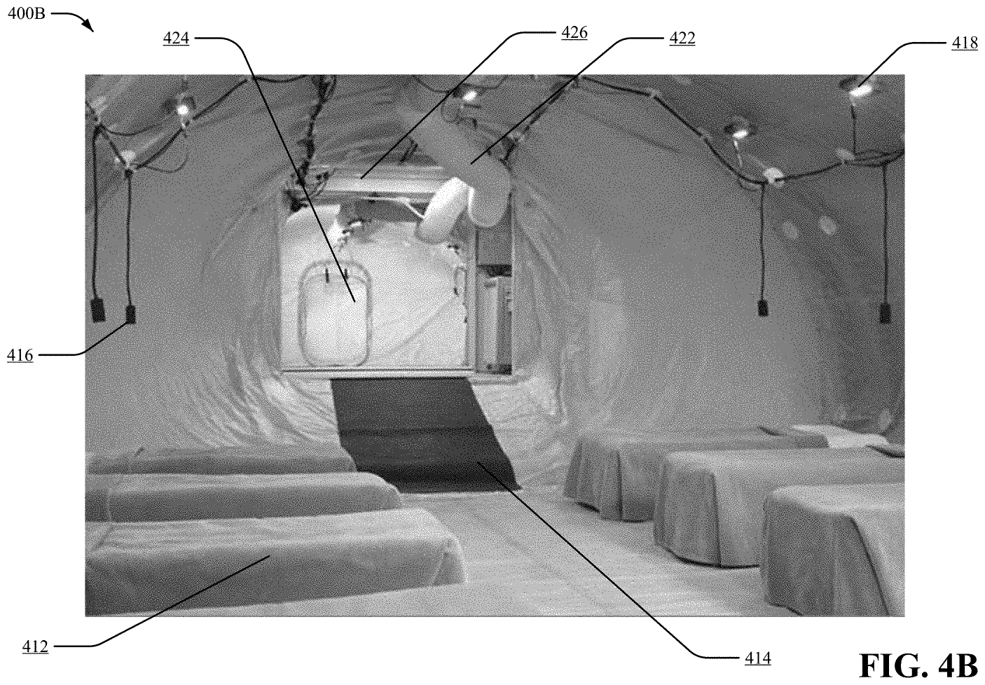

Turning now to FIG. 4A, illustrated is a diagram of an example, non-limiting connection structure of a response system 400A comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 400A can comprise deflated first flexible solar canopy 410A, deflated second flexible solar canopy 410B, first solar storage cabinet 420, second storage cabinet 430, first control panel 440, second control panel 450, connection walkway 470, and electric guide wire 490.

Turning now to FIG. 4B, illustrated is a diagram of an example, non-limiting intensive care unit of a response system 400B comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 400B can comprise bed 412 that includes a bed cover, pillow cover, quilt cover, pillow and quilt. Furthermore, system 400B can comprise connection ramp 414, hanging electrical input 416, first light fixture 418, air duct system 422, inter-container doors 424, and airframe inner cover 426.

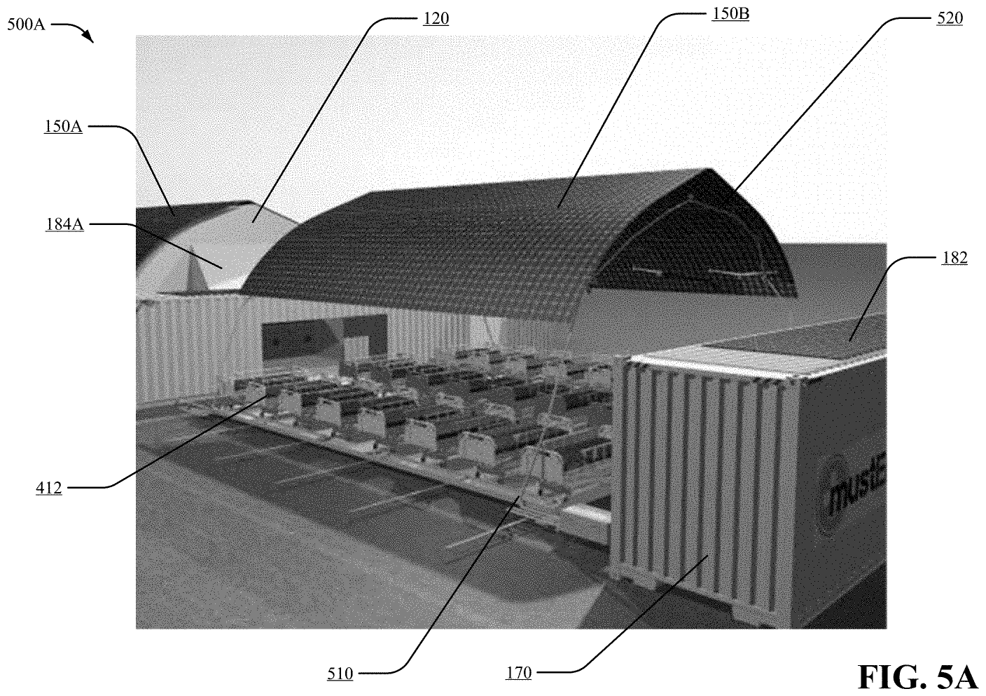

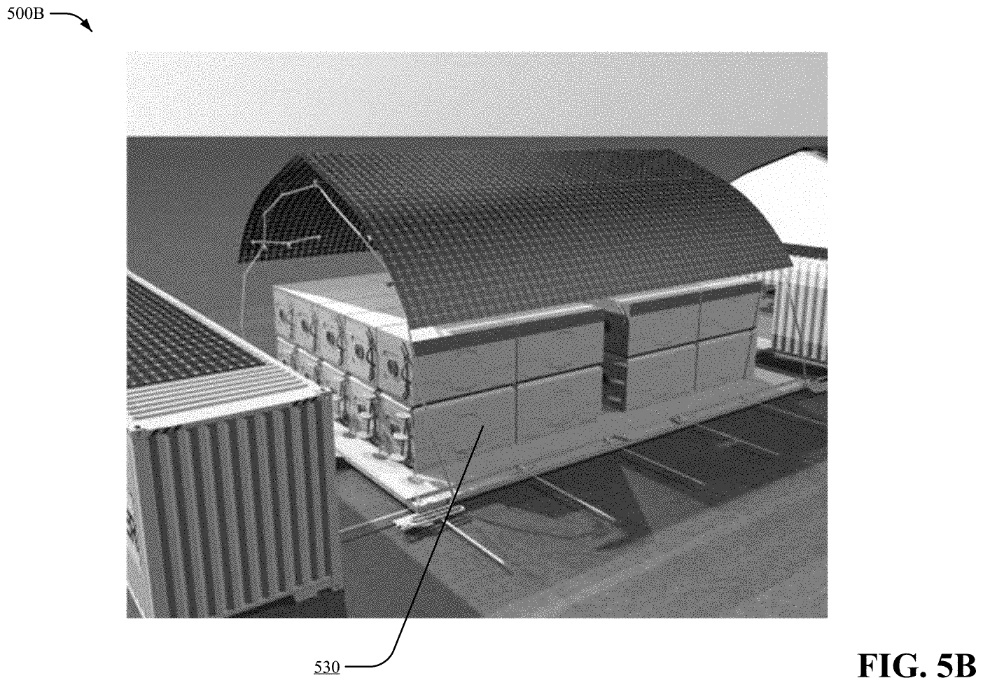

Turning now to FIG. 5A, illustrated is a perspective view of an example, non-limiting intensive care unit of a response system 500A comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 500A can include first airbeam shelter 120, first flexible solar canopy 150A, second flexible solar canopy 150B, third hard container element 170, third flexible solar canopy 182, bed 412, airbeam support pole 510, and airbeam support frame 520.

Turning now to FIG. 5B, illustrated is a perspective view of an example, non-limiting housing unit of a response system 500B comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 500B can include sleeping pod 530.

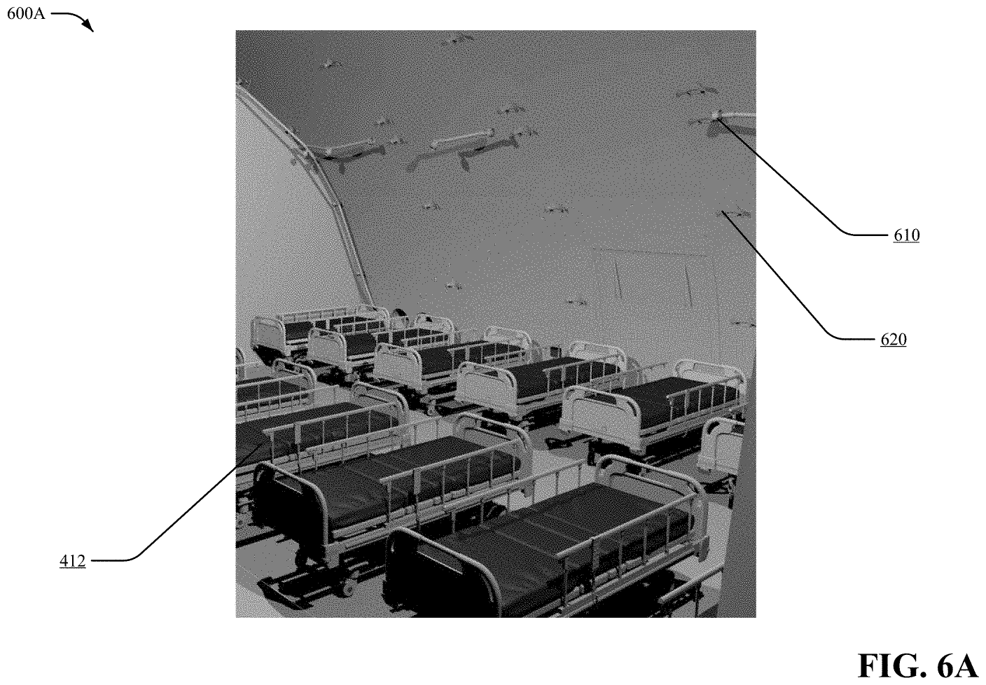

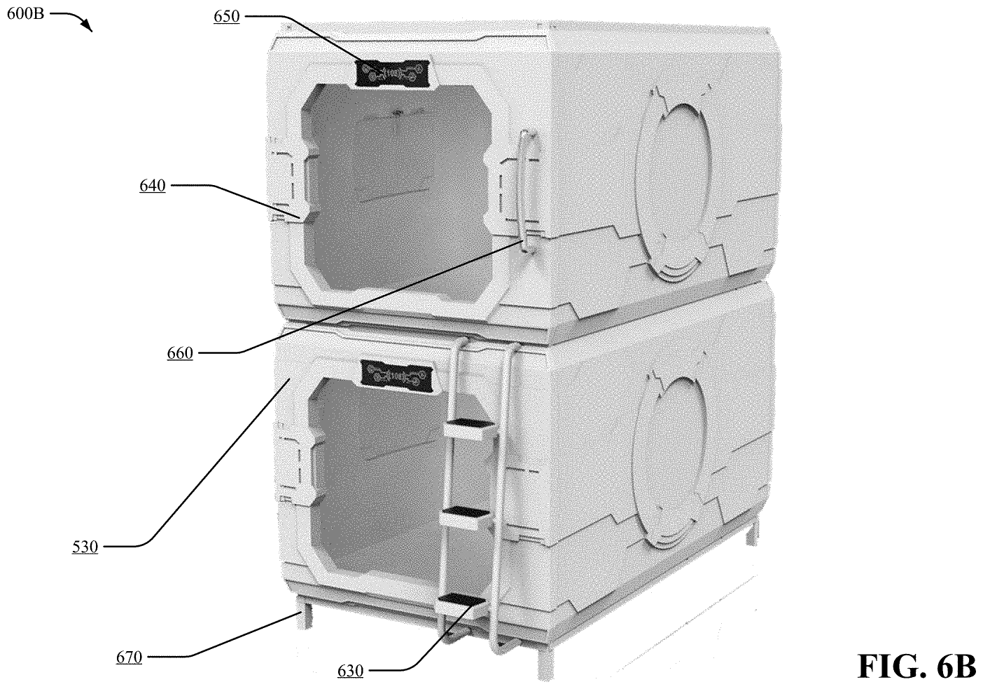

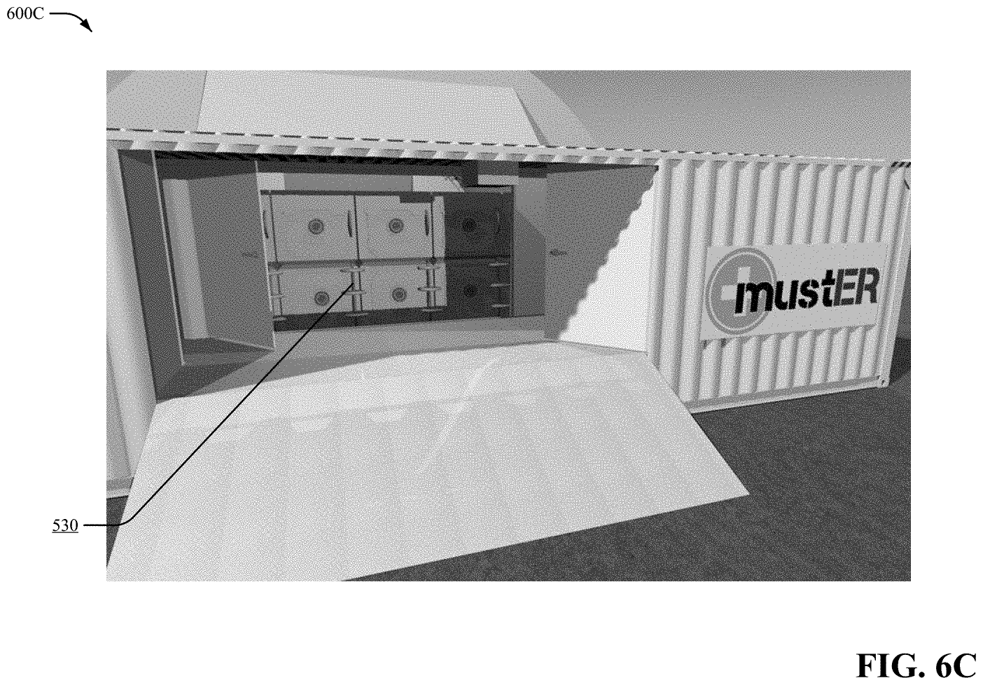

Turning now to FIG. 6A, illustrated is a perspective view of an example, non-limiting housing unit interior of a response system 600A comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 600A can include bed 412, input structure 610, and second light fixture 620.

Turning now to FIG. 6B, illustrated is a perspective view of an example, non-limiting sleeping pod within a housing unit of a response system comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 600B can include sleeping pod 530, pod ladder 630, pod entrance 640, pod display 650, pod handle 660, and pod support leg 670.

Turning now to FIG. 6C, illustrated is a perspective view of an example, non-limiting sleeping pod within a housing unit of a response system comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 600C can include sleeping pod 530.

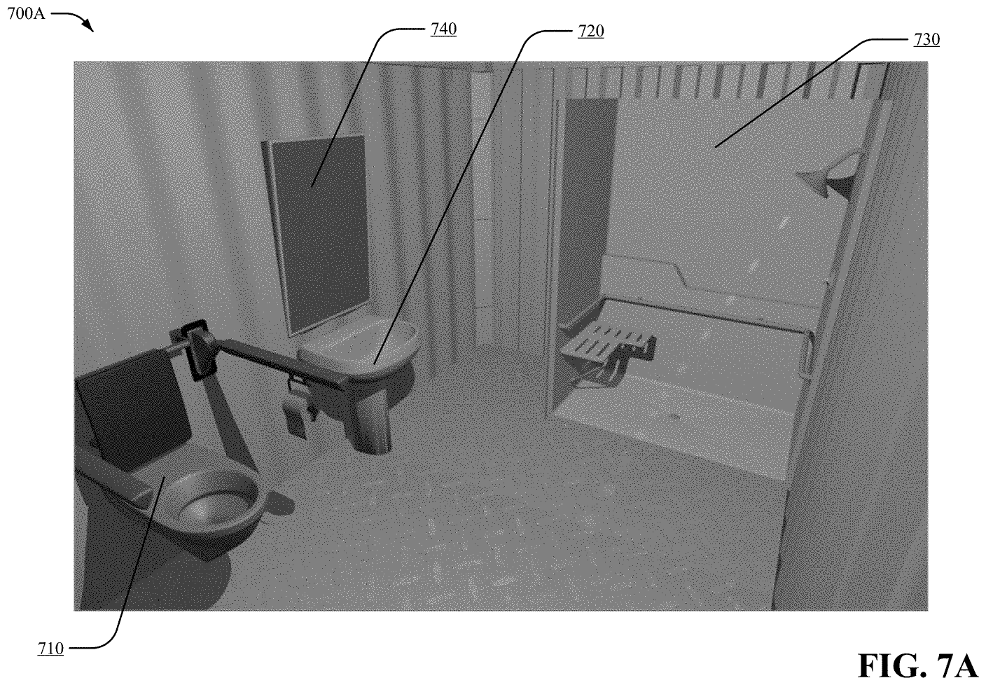

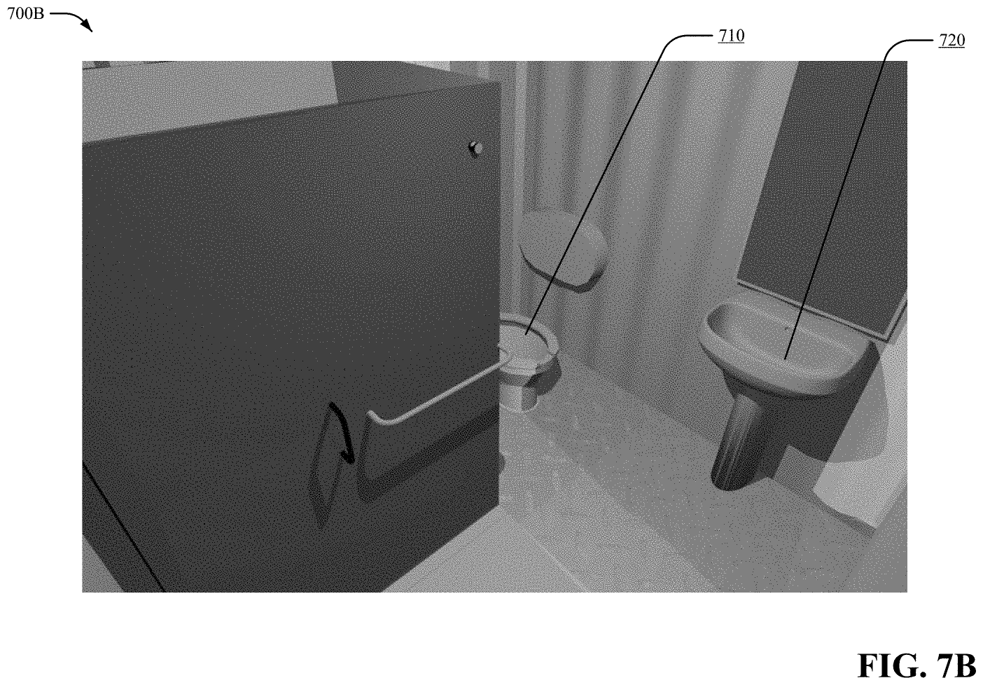

Turning now to FIG. 7A, illustrated is a perspective view of an example, non-limiting washroom within a housing unit of a response system 700A comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 700A can include toilet 710, sink 720, shower unit 730, and mirror element 740.

Turning now to FIG. 7B, illustrated is a perspective view of an example, non-limiting washroom within a housing unit of a response system 700B comprising reusable units such as an integrated array of shelter deployments in response to an emergency, pandemic or other situational need in accordance with one or more embodiments described herein. Repetitive description of like elements employed in other embodiments described herein is omitted for sake of brevity. In an aspect, system 700B can include toilet 710 and sink 720.

1. A method of provisioning a mobile treatment shelter system comprising:
inflating a first deployable shelter unit and a second deployable shelter unit integrated via hermetically sealed doors;
communicatively and electronically connecting the inflated first deployable shelter unit and second deployable shelter unit to at least one microgrid power unit; and
integrating the inflated first deployable shelter unit and second deployable shelter unit with a sanitary septic system.
